(19) United States
(12) Patent Application Publication
(10) Pub. No.: US 2024/0262566 A1
(43) Pub. Date: Aug. 8, 2024

(54) Container With Barrier Member

(71) Applicant: Graphic Packaging International, LLC, Atlanta, GA (US)

(72) Inventors: Simon Holka, Staffanstorp (SE); Inge Berger, Lund (SE)

(21) Appl. No.: 18/429,671

(22) Filed: Feb. 1, 2024

Related U.S. Application Data
(60) Provisional application No. 63/443,100, filed on Feb. 3, 2023.

(51) Int. Cl. B65D 5/56; B31B 50/26; B32B 3/26; B32B 27/08; B32B 27/10; B32B 27/32; B65D 5/12; B65D 5/32; B65D 5/54; B65D 5/66

(52) U.S. Cl. CPC B65D 5/563; B31B 50/26; B32B 3/266; B32B 27/08; B32B 27/10; B32B 27/32; B65D 5/12; B65D 5/326; B65D 5/5405; B65D 5/6697; B32B 2255/12; B32B 2255/20; B32B 2307/7246; B32B 2439/62

(57) ABSTRACT

A container for holding at least one article includes a body extending at least partially around an interior of the container, a reclosable lid engaged with the body, a closed bottom engaged with the body, and a barrier member formed of a laminate structure defining an exterior surface and an interior surface of the barrier member and positioned in the interior of the container, the barrier member having a central portion at least partially separably connected to a marginal portion at a first line of weakening and a second line of weakening, the first line of weakening extending to a first depth from the exterior surface of the barrier member and the second line of weakening extending to a second depth from the interior surface of the barrier member, the first depth different than the second depth, the marginal portion attached to the body.

### CROSS-REFERENCE TO RELATED APPLICATION

The present disclosure claims the benefit of U.S. Provisional Patent Application No. 63/443,100, filed on Feb. 3, 2023.

### INCORPORATION BY REFERENCE

The disclosure of U.S. Provisional Patent Application No. 63/443,100, filed on Feb. 3, 2023, is hereby incorporated by reference for all purposes as if set forth in its entirety.

### BACKGROUND

The present disclosure generally relates to containers for holding one or more articles. In some embodiments, the present disclosure relates to containers having at least one barrier member.

### SUMMARY

According to one aspect, the disclosure is generally directed to a container for holding at least one article, the container comprising a body extending at least partially around an interior of the container, a reclosable lid engaged with the body, the reclosable lid repositionable between an open position, in which the reclosable lid is moved away from the interior of the container, and a closed position, in which the reclosable lid at least partially overlies the interior of the container, a closed bottom engaged with the body, and a barrier member formed of a laminate structure defining an exterior surface and an interior surface of the barrier member and positioned in the interior of the container, the barrier member comprising a central portion at least partially separably connected to a marginal portion at a first line of weakening and a second line of weakening, the first line of weakening extending to a first depth from the exterior surface of the barrier member and the second line of weakening extending to a second depth from the interior surface of the barrier member, the first depth different than the second depth, the marginal portion attached to the body.

According to another aspect, the disclosure is generally directed to a combination of blanks for forming a container for holding at least one article, the combination of blanks comprising a body blank for forming a body extending at least partially around an interior of the container formed from the combination of blanks, a lid blank for forming reclosable lid engaged with the body when the container is formed from the combination of blanks such that the reclosable lid repositionable between an open position, in which the reclosable lid is moved away from the interior of the container formed from the combination of blanks, and a closed position, in which the reclosable lid at least partially overlies the interior of the container formed from the combination of blanks, a bottom blank for forming a closed bottom engaged with the body of the container formed from the combination of blanks, and a barrier blank formed of a laminate structure defining an exterior surface and an interior surface of the barrier blank and for being positioned in the interior of the container formed from the combination of blanks, the barrier blank comprising a central portion at least partially separably connected to a marginal portion at a first line of weakening and a second line of weakening, the first line of weakening extending to a first depth from the exterior surface of the barrier blank and the second line of weakening extending to a second depth from the interior surface of the barrier blank, the first depth different than the second depth, the marginal portion for being attached to the body of the container formed from the combination of blanks.

According to another aspect, the disclosure is generally directed to a method of forming a container for holding at least one article, the method comprising obtaining a body blank, obtaining a lid blank, obtaining a bottom blank, obtaining a barrier blank, the barrier blank formed of a laminate structure defining an exterior surface and an interior surface, the barrier blank comprising a central portion at least partially separably connected to a marginal portion at a first line of weakening and a second line of weakening, the first line of weakening extending to a first depth from the exterior surface of the barrier blank and the second line of weakening extending to a second depth from the interior surface of the barrier blank, the first depth different than the second depth, forming a body of the container from the body blank such that the body extends at least partially around an interior of the container, forming a reclosable lid from the lid blank such that the reclosable lid is engaged with the body, the reclosable lid repositionable between an open position, in which the reclosable lid is moved away from the interior of the container, and a closed position, in which the reclosable lid at least partially overlies the interior of the container, forming a closed bottom from the bottom blank such that the closed bottom is engaged with the body of the container, and attaching the marginal portion of the barrier blank to the body of the container to form a barrier member.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a body blank used to form a body of a container according to an exemplary embodiment of the disclosure.

FIG. 2 is a plan view of an exterior surface of a lid blank for forming a lid or top end of a container according to an exemplary embodiment of the disclosure.

FIG. 3 is a plan view of an exterior surface of a bottom blank for forming a bottom of a container according to an exemplary embodiment of the disclosure.

FIG. 4A is a plan view of an exterior surface of a barrier blank for forming a barrier member of a container according to an exemplary embodiment of the disclosure.

FIG. 4B is a plan view of the interior surface of the barrier blank of FIG. 4A.

FIG. 4C is a cross-sectional view of the barrier blank of FIG. 4A.

FIG. 5 is a cross-sectional view showing the formation of lines of weakening on the barrier blank of FIG. 4A.

FIGS. 6A-6C are sequential perspective views of a formation of a container according to an exemplary embodiment of the disclosure.

FIG. 7 is a perspective view illustrating accessing an interior of the container formed from the blanks of FIGS. 1-4C according to an exemplary embodiment of the disclosure

Corresponding parts are designated by corresponding reference numbers throughout the drawings.

### DETAILED DESCRIPTION

Containers according to the present disclosure can accommodate articles of numerous different shapes. For the purpose of illustration and not for the purpose of limiting the scope of the disclosure, the following detailed description describes articles such as food products. Such food products can be provided in discrete or granular portions, e.g., as in snacks, for example, candy, gum, chocolate, granola, cereal, nuts, trail mix, raisins, dried fruit, etc. It will be understood that a different type of article such as a different type of food product or different type of article, e.g., powdered food products or powdered articles, can be held in containers according to the present disclosure without departing from the disclosure. It will be further understood that articles other than food products can be held in containers according to the present disclosure.

In this specification, the terms “lower,” “bottom,” “upper,” and “top” indicate orientations determined in relation to fully erected and upright containers. As described herein, containers can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

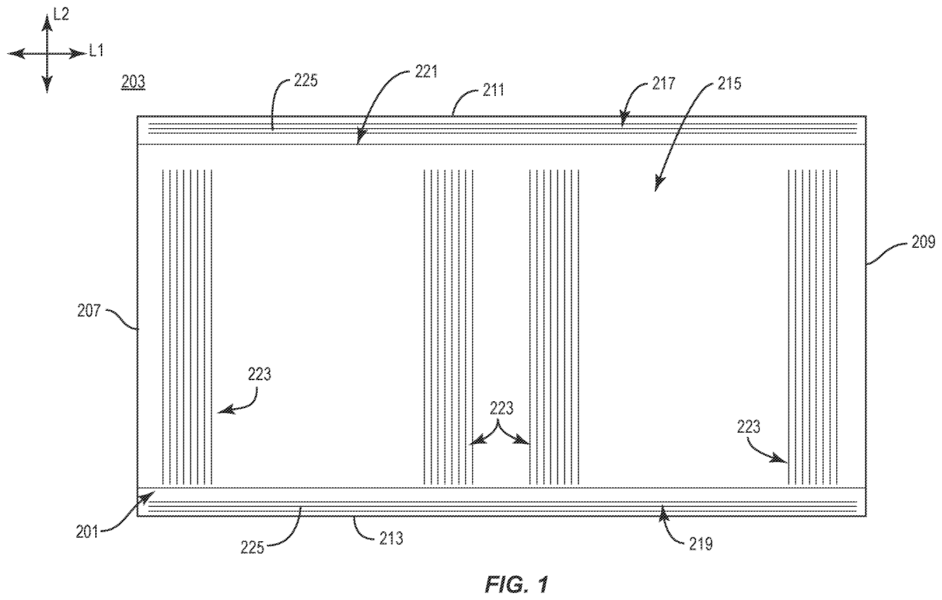

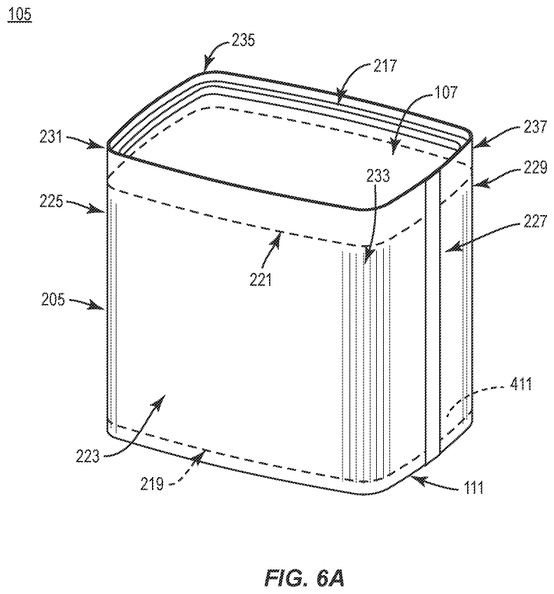

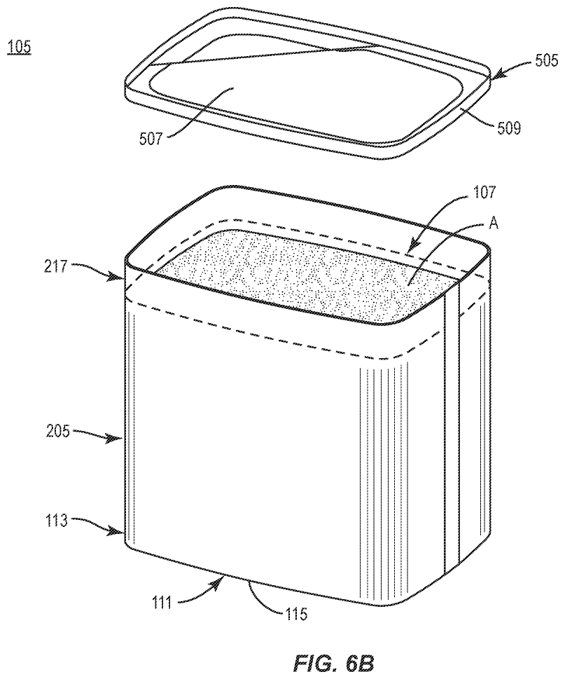

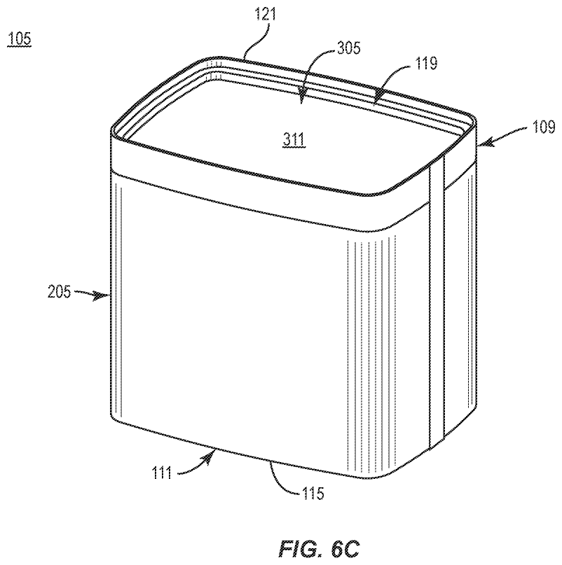

FIGS. 1-4C are plan views of a series of blanks used to form components that assemble to form a container 105 (FIG. 6C) according to an exemplary embodiment of the present disclosure. In this regard, in some embodiment the container 105 can be considered an assembly or system of a plurality of components.

Referring to FIG. 1, a plan view of an exterior surface 201 of a body blank 203 for forming a body 205 of the container 105 is illustrated. As described herein, the body 205 is arranged to extend at least partially around an interior 107 of the container 105.

As shown, the body blank 203 can have a longitudinal axis L1 and a lateral axis L2. In some embodiments, the axes L1, L2 can be transposed. In the illustrated embodiment, the body blank 203 can have a generally rectangular configuration with a pair of opposite lateral free edges 207, 209 and a pair of opposite longitudinal free edges 211, 213 extending from a respective endpoint of the free edge 207 to a respective endpoint of the free edge 209.

The body blank 203 can also include a body forming portion 215 defined along a central portion of the body blank 203, a first or top end or lid forming portion 217 defined at an upper peripheral portion/upper marginal portion of the body blank 203, and a second or bottom end forming portion 219 defined at a lower peripheral portion/lower marginal portion of the body blank 203.

As shown, the lid forming portion 217 of the body blank 203 can be at least partially separably connected to the body forming portion 215 and at least partially foldably connected to the body forming portion 215 at a longitudinal line of weakening 221 that can include at least one tear segment and at least one fold line segment.

With continued reference to FIG. 1, the body blank 203 can include a multiple pluralities of lateral lines of weakening 223 that can facilitate the formation of curved corners when the body 205 is formed from the body blank 203, as described further herein.

The body blank 203 can also include one or more pluralities of longitudinal lines of weakening 225 extending therealong. In the illustrated embodiment, the body blank 203 can include a plurality of longitudinal lines of weakening 225 extending across the lid forming portion 217 and another plurality of longitudinal lines of weakening 225 extending along the body forming portion 219. As described further herein, the lines of weakening 225 can facilitate formation of the body 205 from the body blank 203.

In some embodiments, the body blank 203 can be comprised of one or more paperboard materials made predominantly from cellulose fibers or paper fibers. The material may be provided in the form of a continuous web or may be provided as individual sheets of material. The paperboard material may be a single ply or multi ply material and may be a laminate comprising one or more reinforcing, moisture resistant non-cellulosic layers of materials such as films and coatings, metal foil, etc. The paperboard material may be coated, printed, embossed, etc. and may comprise fillers, pigments, binders and other additives as known in the art. In some embodiments, the paperboard material can be devoid of polymeric and/or metallic materials.

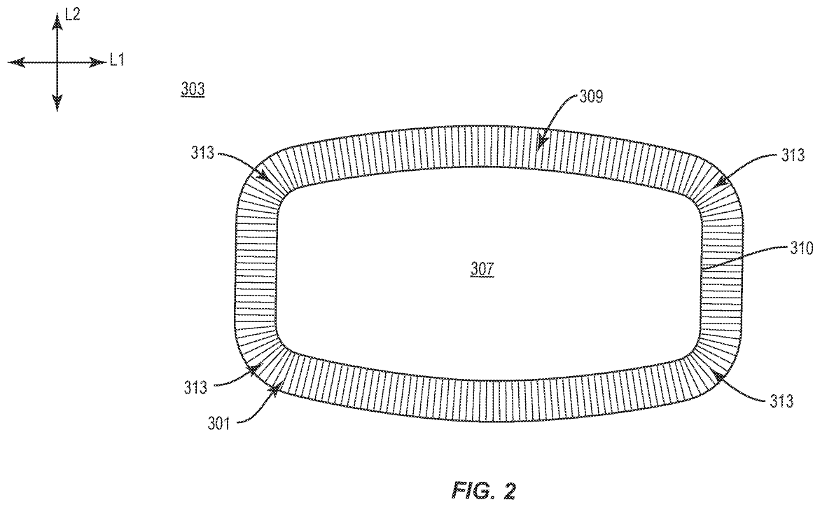

Turning to FIG. 2, the exterior surface 301 of a lid blank 303 for at least partially forming a lid 109 of the container 105 is illustrated. As shown, the lid blank 303 can have the longitudinal axis L1 and the lateral axis L2, and can include a central portion 307 and a marginal portion 309 extending to the peripheral edges of the lid blank 303.

In some embodiments, the marginal portion 309 of the lid blank 303 can be at least partially foldably connected to the central portion 307 at a generally rounded rectangular/elliptical fold line 310. In other embodiments, one or more foldable connections between the marginal portion 309 of the lid blank 303 and the central portion 307 of the lid blank 303 can be formed upon formation of the lid 109 of the container 105, as described further herein.

As also shown, the lid blank 303 can include multiple pluralities of oblique and/or curved lines of weakening 313 arranged along corner portions of the lid blank 303. As described further herein, the lines of weakening 313 can facilitate formation of the lid 109/container 105.

It will be understood that the lid blank 303 can be formed from one or more materials that are the same or similar to those that form the body blank 203 as described above, e.g., paperboard materials.

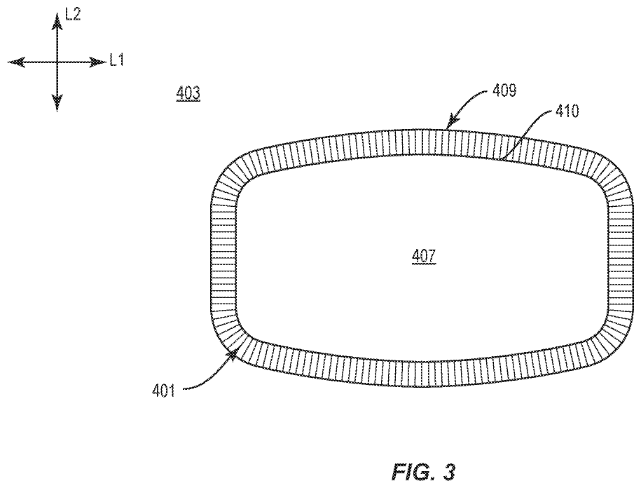

Turning to FIG. 3, the exterior surface 401 of a bottom blank 403 for at least partially forming a closed bottom or closed end 111 of the container 105 is illustrated.

As shown, the bottom blank 403 can have a configuration generally similar to that of the lid blank 303 described above, e.g., having the longitudinal axis L1 and the lateral axis L2, a central portion 407, and a marginal portion 409 extending to the peripheral edges of the bottom blank 403. In the illustrated embodiment, the marginal portion 409 can be at least partially foldably connected to the central portion 407 at a generally rounded rectangular/elliptical fold line 410, though the blank 403 can be devoid of the fold line 410 without departing from the disclosure.

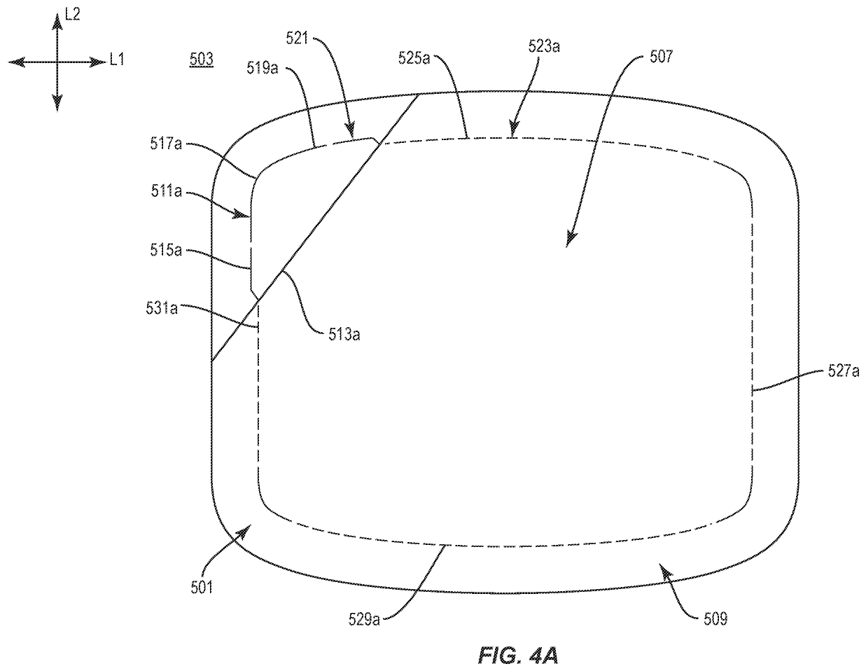

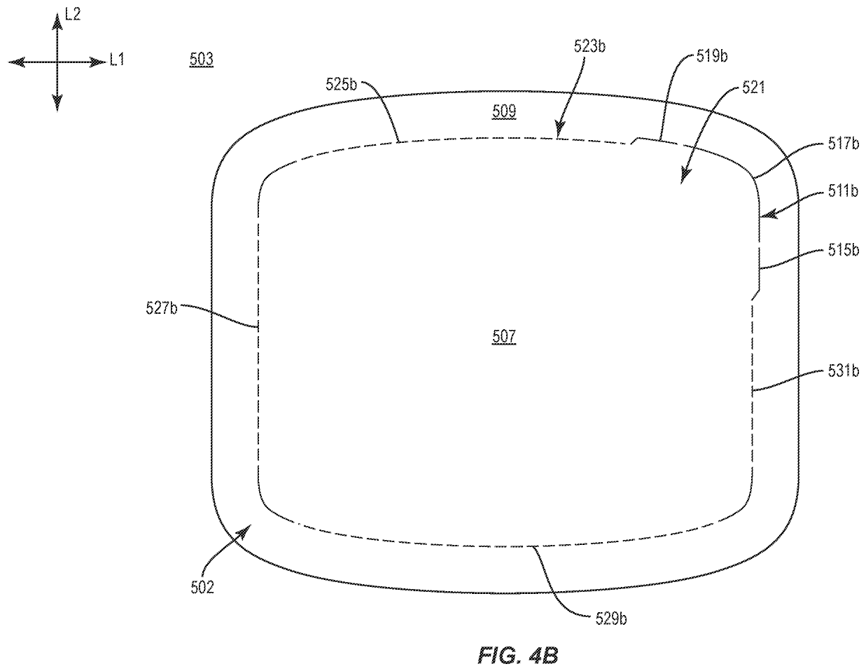

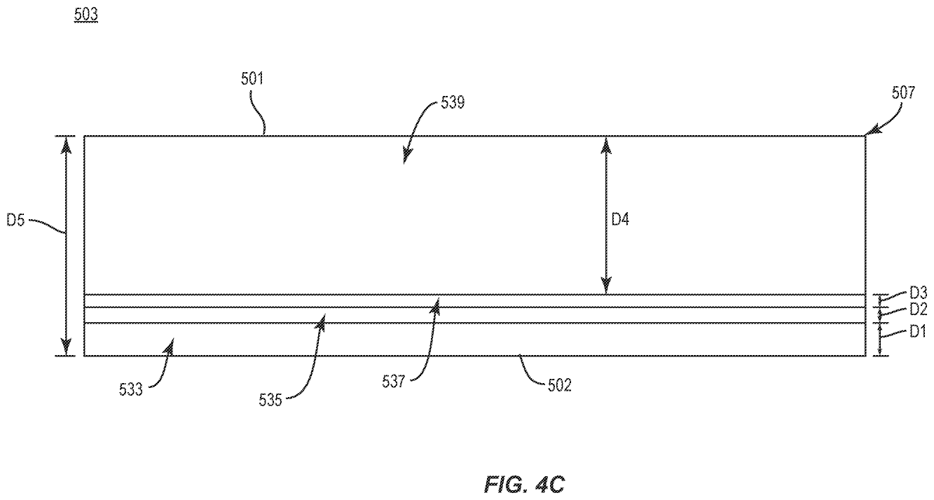

Turning to FIG. 4A, the exterior surface 501 of a barrier blank 503 for forming a barrier member 505 of the construct 105 is illustrated. FIG. 4B is a plan view of the interior surface 502 of the barrier blank 503 and barrier member 505 formed therefrom. With additional reference to FIG. 4C, a schematic cross-sectional view of the barrier blank 503 is illustrated.

The barrier blank 503 can have the longitudinal axis L1 and the lateral axis L2, and can include a central portion 507 and a marginal portion 509 extending to the peripheral edges of the barrier blank 503. In some embodiments, the marginal portion 509 of the barrier blank 503 can be at least partially foldably connected to the central portion 507 at one or more lines of weakening, e.g., fold lines. In other embodiments, one or more foldable connections between the marginal portion 509 of the blank 503 and the central portion 507 of the blank 503 can be formed upon formation of the barrier member 505.

As shown in FIG. 4A, the marginal portion 509 of the blank 503 can be at least partially separable from the central portion 507 of the blank 503 and barrier member 505 formed therefrom at an upper at least partially curved line of weakening 511a and an upper oblique line of weakening 513a. As shown, the line of weakening 511a can include a lateral segment 515a, a curved segment 517a, and a longitudinal segment 519a. In some embodiments, an access feature 521 can be defined in the central portion 507 between the lines of weakening 511a, 513a to facilitate separation of the central portion 507 from the marginal portion 509.

The marginal portion 509 of the blank 503 and barrier member 505 formed therefrom can be at least partially defined by a line of weakening 523a (broadly, “first line of weakening”) that includes a first curved segment 525a intersecting and extending away from an endpoint of the line of weakening 513a, a generally lateral segment 527a intersecting the segment 525a and extending away therefrom, a curved segment 529a intersecting the segment 527a and extending away therefrom, and a generally lateral segment 531a intersecting the segment 529a and extending away therefrom, the segment 531a also intersecting an endpoint of the line of weakening 513a.

With additional reference to FIG. 4B, in the illustrated embodiment, the interior surface 502 of the blank 503 and the barrier member 505 formed therefrom can have an arrangement of lines of weakening that are generally a mirror image of those described above with respect to the exterior surface 501 of the blank 503 and barrier member 505 formed therefrom. Corresponding components have been designated by corresponding reference numbers that differ by the “a” or “b” suffix, with the “a” components corresponding to the exterior surface 501 of the blank 503 and barrier member 505 formed therefrom, and the “b” components corresponding to the interior surface 502 of the blank 503 and barrier member 505 formed therefrom. In one embodiment, the interior surface 502 of the blank 503 and barrier member 505 formed therefrom can be devoid of a line of weakening corresponding to the line of weakening 513a of the exterior surface 501 of the blank 503 and barrier member 505 formed therefrom.

In the illustrated embodiment, and with additional reference to FIG. 4C, the barrier blank 503 and barrier member 505 formed therefrom can be formed from a laminate structure 507 that forms the exterior surface 501 and the interior surface 502 of the blank 503/barrier member 505 formed therefrom, and that includes a plurality of layers in general registration, with vertically adjacent layers in overlapping and/or at least partial face-to-face contact with one another.

As shown, the laminate structure 507 can include a first polymer layer 533, a second polymer layer 535 overlapping and/or in at least partial face-to-face contact with the first polymer layer 533, a third polymer layer 537 overlapping and/or in at least partial face-to-face contact with the second polymer layer 535, and a composite layer 539 overlapping and/or in at least partial face-to-face contact with the third polymer layer 537.

In some embodiments, the polymer layers 533, 535, 537, 539 comprise polyethylene, though one or more of the polymer layers 533, 535, 537, 539 can have a different composition without departing from the disclosure. In some embodiments, the polymer layer 537 can be a high density polyethylene (HDPE), e.g., having a density that is greater than that of the material that forms the polymer layers 533, 535.

In some embodiments, the composite layer 539 can comprise a paper or paperboard product such as kraft paper, parchment, clay-coated paperboard, solid bleached board (SBB) paperboard, solid bleached sulphate (SBS) paperboard, Kraft line paperboard, cardboard, or another suitable material that may be degradable, compostable, and/or repulpable.

The layers 533, 535, 537, 539 can be laminated or otherwise combined to form the laminate structure 507, e.g., through pressing, at least partial heating of one or more layers thereof, welding, sealing, and/or adhesion with an adhesive such as glue.

In some embodiments, the polymer layer 533 can have a thickness D1 of about 0.07 mm, the polymer layer 535 can have a thickness D2 of about 0.05 mm, the polymer layer 537 can have a thickness D3 of about 0.03 mm, and the composite layer 539 can have a thickness D4 of about 0.4 mm, though one or more of the layers 533, 535, 537, 539 can have a different thickness without departing from the disclosure. In such embodiments, the laminate structure 507 can have an overall thickness D5 of about 0.55 mm.

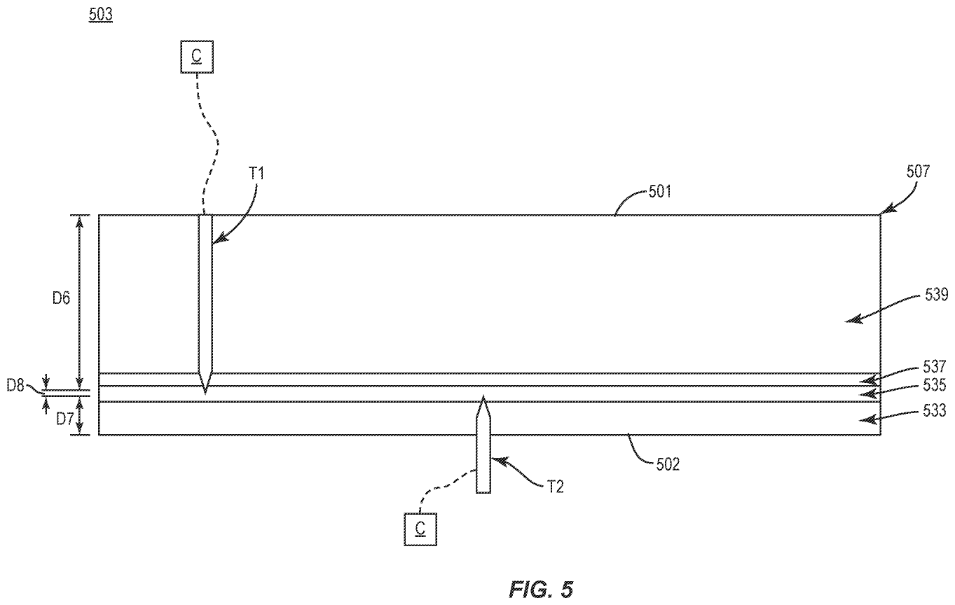

With additional reference to FIG. 5, an exemplary process for forming the lines of weakening 511a, 511b, 513a, 523a, 523b (broadly, “second line of weakening”) is illustrated. In one embodiment, the lines of weakening 511a, 513a, 523a, 523b can be at least partially formed by a cutting tool, e.g., a die cutting tool or other precision cutting instrument. As shown, a first cutting tool T2 can be provided for cutting into the exterior surface 101 of the blank 503 and barrier member 505 formed therefrom, and a second cutting tool T2 can be provided cutting into the interior surface 102 of the blank 103 and barrier member 105 formed therefrom.

The cutting tools T1, T2 can be formed with a generally tapered structure that converges at a cutting point or cutting tip. In this regard, the cutting tools T1, T2 can be at least partially comprised of a hardened material suitable for making cuts, e.g., a metallic and/or composite material. In some embodiments, the cutting tools T1, T2 can be defined by cutting edges that are arranged at respective angles of about 42°, though it will be understood that one or both of the cutting tools T1, T2 can be differently dimensioned and/or arranged without departing from the disclosure.

In the illustrated embodiment, each cutting tool T1, T2 can be movably supported a distance spaced away from a respective surface 501, 502 of the blank 503 and barrier member 505 formed therefrom, and can be moveable toward or away from the blank 503/barrier member 505, for example, via an actuator coupled thereto and moveable upon receiving one or more electrical signals from a controller C. Such controller C can include a processor configured to implement one or more instructions stored on a non-transitory storage medium, and can be configured for operator input and/or manual control. In this regard, the controller C can be or can form a part of a software program running on a computer, a programmable logic controller (PLC), another processor-implemented controller, or other control feature. In the illustrated embodiment, each tool T1, T2 is in electrical communication with a respective controller C, though it will be understood that a single controller or a network of controllers can be in electrical communication with both tools T1, T2.

It will be understood that lines of weakening as described herein can be effected by relative movement of the blank 503 and the cutting tool(s) T1, T2 such that, in some embodiments, the blank 503 can be moved relative to the cutting tool(s) T1, T2. For example, in other embodiments, the cutting tools T1, T2 can be edges of a cutting knife(s) supported in and protruding from a frame in a die cutting assembly. In some embodiments, the cutting tools T1, T2 can be edges of cutting knives supported in and protruding from different frames. In such embodiments, a die tool, for example, under control of a controller C, can be actuated to urge the blank 503 into contact with the cutting tools T1, T2 to effect at least partial cutting thereof. In still other embodiments, cutting can be effected with tools that do know employ knives or knife edges, such that the cutting tools T1, T2 can be electromagnetic beams such as lasers. Accordingly, the cutting operations described herein are illustrated schematically.

As shown, the cutting tool T1 can be actuated and moved toward the exterior surface 501 of the blank 503/barrier member 505, or vice versa, to pierce and extend through the composite layer 539, the third polymer layer 537, and partially through the second polymer layer 535 to a depth D6 (broadly, “first depth”) measured from the exterior surface 501 to form the lines of weakening 511a, 513a, 523a. The cutting tool T2, as shown, can be actuated and moved toward the interior surface 502 of the blank 503/barrier member 505, or vice versa, to pierce and extend through the first polymer layer 533 and partially through the second polymer layer to a depth D7 (broadly, “second depth”) measured from the interior surface 502 to form the lines of weakening 511b, 523b.

In this regard, the depth D6 can be such that D3+D4<D6<D2+D3+D4 and the depth D7 can be such that D1<D6<D1+D2. In some embodiments, D6 can be about 0.46 mm and D7 can be about 0.1 mm, though one or both of D6 and D7 can be different without departing from the disclosure.

Accordingly, the cutting tool T1 can be inserted to the depth D6 from the exterior surface 501 of the blank 503/barrier member 505, or vice versa, so as to partially pierce but not fully extend through the second polymer layer 535, and the cutting tool T2 can be inserted to the depth D7 from the interior surface 502 of the blank 503/barrier member 505, or vice versa, so as to partially pierce but not fully extend through the second polymer layer 535.

Thus, the lines of weakening 511a, 513a, 523a can be formed by the cutting tool T1, and the lines of weakening 511b, 523b can be formed by the cutting tool T2, with the lines of weakening 511a, 513a, 523a spaced apart from the lines of weakening 511b, 523b by a thickness D8 of a portion of the second polymer layer 535, where D8=D5−(D6+D7).

The aforementioned arrangement of lines of weakening allows a portion of the blank 503/barrier member 505 to remain intact, e.g., such that none of the lines of weakening 511a, 511b, 513a, 523a, 523b extend therethrough. In the illustrated embodiment, such portion of the blank 503/barrier member 505 can be a portion of the second polymer layer 535, which can advantageously maintain barrier properties of the blank 503/barrier member 505 proximate the lines of weakening 511a, 511b, 513a, 523a, 523b.

One or more of the blanks 203, 303, 403, 503 and one or more of the associated features thereof can have a different arrangement and/or configuration without departing from the disclosure. For example, and as described further herein, the body blank 203 can be formed into a body 205 of the container 105 with a generally rounded rectangular or elliptical vertical cross-section, with each of the blanks 303, 403, 503 having a corresponding cross-section for being at least partially received in the interior 107 of the container 105/body 205. In some embodiments, the body 205 can be formed with a different vertical cross-sectional configuration, and the blanks 303, 403, 503 can have a different configuration corresponding to such vertical cross-sectional configuration.

As described herein, the blanks 203, 303, 403, 503 can be further formed to provide components that assemble to form the container 105. In this regard, the blanks 203, 303, 403, 503 can be provided in combination for forming a system in the form of the container 105.

Turning to FIGS. 6A-6C, formation of the container 105 from the blanks 203, 303, 403, 503 will be described according to an exemplary embodiment of the disclosure.

The body blank 203 can be positioned to extend at least partially around an interior 107 of the container 105. In one embodiment, the body blank 203 can be at least partially bent, curved, folded, etc., for example, at the fold lines 223, into a generally elliptical or rounded rectangular cross-section, with portions of the body blank 203 proximate the free edges 207, 209 at least partially overlapped to form a seam arrangement, which can be maintained with a strip of adhesive tape. In some embodiments, the free edges 207, 209 of the blank 203 can be brought into generally edge-to-edge contact.

The overlapping/meeting portions of the body blank 203 can be joined, for example, with an adhesive such as glue, with an adhesive coated tape or substrate, and/or through another method of joining such as welding, interfering locking arrangements, etc.

As shown, the body 205 of the container 105 can thus be formed, with respective portions of the body forming portion 215 of the blank 203 forming a front wall or front panel 223, a first side wall or first side panel 225, a second side wall or second side panel 227, and a back wall or back panel 229. Respective curved corners 231, 233, 235, 237 can be formed between the respective panels 223, 225, the respective panels 223, 227, the respective panels 225, 229, and the respective panels 227, 229.

As described above, in some embodiments, the body 205 of the container 105 can be formed into a different cross-sectional configuration, e.g., circular, elliptical, triangular, rectangular, square, pentagonal, hexagonal, heptagonal, octagonal, etc., including rounded or curved corner variations thereof.

With continued reference to FIGS. 6A-6C, the closed bottom 111 of the container 105 can be formed, according to the illustrated embodiment, by positioning the bottom blank 403 in the interior 107 of the container 105, with the central portion 407 of the bottom blank 403 positioned in generally perpendicular relation with the panels 223, 225, 227, 229 so as to form a bottom panel 411 of the container 105. As shown, the bottom blank 403 can be positioned a vertical distance above the longitudinal free edge 213 of the blank 203.

The marginal portion 409 of the bottom blank 403 can be bent or folded downwardly relative to the central portion 407 of the blank 403/bottom panel 411, for example, at the fold line 410, and attached, e.g., adhered with an adhesive such as glue, welded, or otherwise attached, to the interior surface of one or more of the panels 223, 225, 227, 229 and corners 231, 233, 235, 237 of the body 205 of the container 105 to engage the closed bottom 111 with the body 205 of the container 105.

Simultaneously or thereafter, the bottom forming portion 219 of the blank 203 can be bent/curled or folded, for example, at the fold lines 225, over the marginal portion 409 of the bottom blank 403 to form a bottom flange 113 of the container 105 that extends downwardly from the bottom panel 411. In some embodiments, the bottom forming portion 219 of the blank 203 can be crimped in such an arrangement. The bottom flange 113 can define a bottom edge 115 of the container 105.

With continued reference to FIGS. 6A-6C, the container 105 having the closed bottom 111 can be positioned, e.g., with the bottom flange 113 extending downwardly, supported on a surface such as a conveyor for being positioned below a filling station within which one or more articles A can be deposited and held in the interior 107 of the container 105. In some embodiments, a container 105 can be supported in a generally stationary position and one or more filling devices can be brought into proximity with the container 105 for depositing articles in the interior 107 of the container 105.

After filling the interior 107 of the container 105 with articles, the barrier blank 503 can be positioned in the interior 107 of the container 105 above the articles, with the central portion 507 of the barrier blank 503 positioned in generally perpendicular relation with the panels 223, 225, 227, 229. As shown, the barrier blank 503 can be positioned a vertical distance below the longitudinal free edge 211 of the blank 203/body 205.

In some embodiments, the barrier blank 503 can be inserted into the interior 107 of the container 105, formed into the barrier member 505, and/or attached to the body 205 of the container 105 via contact with a plunger or other moveable tool for positioning the blank 503/member 505.

In this regard, at least a portion of the marginal portion 509 of the blank 503/barrier member 505 can be bent or folded downwardly relative to the central portion 507 of the barrier blank 503 and attached, e.g., adhered with an adhesive such as glue, welded, or otherwise attached, to the interior surface of one or more of the panels 223, 225, 227, 229 and corners 231, 233, 235, 237 of the body 205 of the container 105 to form the barrier member 505.

Following formation and positioning of the barrier member 505, the lid blank 303 can be positioned in the interior 107 of the container 105 above the barrier member 505. As shown, the lid blank 303 can be positioned a vertical distance below the longitudinal free edge 211.

The central portion 307 of the lid blank 303 can be positioned in generally perpendicular relation with the panels 223, 225, 227, 229 so as to form a lid panel 311 of the container 105.

The marginal portion 309 of the lid blank 303 can be bent or folded downwardly relative to the central portion 307 of the blank 303/lid panel 311, for example, at the fold line 310, and attached, e.g., adhered with an adhesive such as glue, welded, or otherwise attached, to the interior surface of one or more of the panels 223, 225, 227, 229 and corners 231, 233, 235, 237 of the body 205 of the container 105. It will be understood that the lines of weakening 313 can facilitate positioning of the marginal portion 309 relative to corners 231, 233, 235, 237.

Simultaneously or thereafter, the lid forming portion 217 of the blank 203 can be bent/curled or folded, for example, at the fold lines 225, over the marginal portion 309 of the lid blank 303 to form a lid collar or lid flange 119 of the lid 109 of the container 105. In some embodiments, the lid forming portion 217 of the blank 203 can be crimped in such an arrangement. The lid flange 119 can define a top edge 121 of the lid 109/container 105.

In some embodiments, the aforementioned assembly of the components of the container 105 can proceed in a different order. For example, in some embodiments, the lid 109 of the container 105 can be assembled and the barrier member 505 can be formed and positioned in the interior 107 of the container 105 and attached to the body 205 of the container 105 prior to the formation of the closed bottom 111 of the container 105. In such embodiments, the container 105 having the formed lid 109 and barrier member 505 can be positioned, in an inverted orientation, under a filling station such that articles A can be deposited in the interior 107 of the container 105 atop the barrier member 505. The closed bottom 111 of the container 105 can then be formed in the manner described above to provide the filled container 105 in an inverted orientation, which can be reoriented as desired.

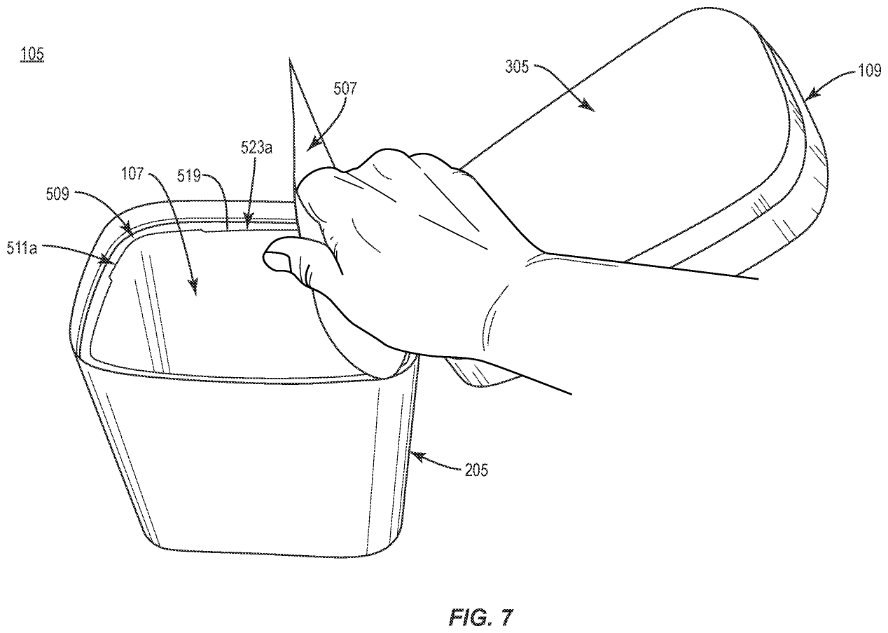

With additional reference to FIG. 7, in order to access the interior 107 of the container 105, a user can separate the lid 109 from the body 205 of the container 105 along tear line segments of the line of weakening 221 and hingably/foldably move the lid 109 about a fold line segment of the line of weakening 221 to allow the lid 109 to be arranged in an open position, in which the lid 109 is moved away from the interior 107 of the container 105, and a closed position, in which the lid 109 at least partially overlies and/or is at least partially received in the interior 107 of the container 105. It will be understood that the lid 109 can be positioned again in the closed position by reversing the foregoing steps such that the lid 109 has a reclosable configuration.

When the lid 109 is in an open position, a user can remove the barrier member 505 to access articles A held therebeneath. In one embodiment, the user can press the barrier member 505 downwardly at the access feature 515 to cause at least partial separation of the central portion 507 from the marginal portion 509 of the barrier member 505 at the lines of weakening 511a, 511b, 513a, 523a, 523b. Movement of the access feature 521 can be at least partially facilitated by the line of weakening 513a to which the access feature 521 is foldably connected to a portion of the central portion 507 of the barrier blank 503/barrier member 505.

Upon at least partial separation of the central portion 507 of the barrier member 505 a described above, a user can insert on or more of his or her fingers into the interior 107 of the container 105 below the barrier member 505 to engage the interior surface 502 of the barrier member 505 and pull the central portion 507 thereof upwardly to cause separation of the central portion 507 from the remainder of the marginal portion 509 along respective segments of the lines of weakening 523a, 523b.

In this regard, upon pushing and/or pulling by a user on the barrier member 505, one or both of the lines of weakening 523a, 523b can be caused to propagate further along the second polymer layer 535 to allow for separation of the central portion 507 from the marginal portion 509 of the barrier member 505 to expose a barrier opening in the interior 107 of the container 105 for accessing one or more articles A in the interior 107 of the container 105.

Due to the configuration of the barrier member 505 and the lines of weakening formed therealong formed by separate cuts by tools T1, T2 along opposing surfaces of the blank 503/barrier member 505, a portion of the blank 503/barrier member 505, e.g., a portion of the second polymer layer 535, is maintained until manually breached by a user. In this regard, the blank 503/barrier member 505 can provide superior barrier properties to maintain one or more conditions of articles A in the interior 107 of the container 105, e.g., to maintain freshness, to maintain a sealed condition thereof, to maintain a moisture barrier, to avoid contact with debris from the environment, to prevent access by pests, etc., for example, as compared to a barrier member in which lines of weakening fully penetrate such structures. Furthermore, this arrangement of lines of weakening in the blank 503/barrier member 505 can provide superior tear resistance to incidental forces, e.g., those not intentionally applied by a user during opening, for example, during installation of the blank 503/barrier member 505 in the interior 107 of the container 105, during storage and/or transport, pressure changes, etc.

It will be understood that the container 105 and/or one or more components thereof can have a different configuration without departing from the disclosure. For example, it will be understood that one or more of the blanks and members described herein can be shaped, sized, or otherwise configured to engage such container structures. Such container structures can include Boardio®, available from Graphic Packaging International, LLC of Atlanta, GA, Sealio®, available from Graphic Packaging International, LLC of Atlanta, GA, and Cekacan®, available from Graphic Packaging International, LLC of Atlanta, GA, to name a few.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the containers to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure container panels or portions in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one article, the container comprising:
a body extending at least partially around an interior of the container;
a reclosable lid engaged with the body, the reclosable lid repositionable between an open position, in which the reclosable lid is moved away from the interior of the container, and a closed position, in which the reclosable lid at least partially overlies the interior of the container;
a closed bottom engaged with the body; and
a barrier member formed of a laminate structure defining an exterior surface and an interior surface of the barrier member and positioned in the interior of the container, the barrier member comprising a central portion at least partially separably connected to a marginal portion at a first line of weakening and a second line of weakening, the first line of weakening extending to a first depth from the exterior surface of the barrier member and the second line of weakening extending to a second depth from the interior surface of the barrier member, the first depth different than the second depth, the marginal portion attached to the body.

2. The container of claim 1, wherein the central portion of the barrier member is at least partially separable from the marginal portion of the barrier member for exposing a barrier opening for accessing at least one article in the interior of the container.

3. The container of claim 2, wherein the laminate structure comprises a composite layer and at least one polymer layer.

4. The container of claim 3, wherein the at least one polymer layer is a polymer layer of a plurality of polymer layers.

5. The container of claim 4, wherein the polymer layer comprises high density polyethylene (HDPE).

6. The container of claim 5, wherein the polymer layer is a third polymer layer in at least partial face-to-face contact with the composite layer, and the laminate structure comprises a second polymer layer in at least partial face-to-face contact with the third polymer layer and a first polymer layer in at least partial face-to-face contact with the second polymer layer.

7. The container of claim 6, wherein each of the first polymer layer and the second polymer layer comprises polyethylene, and each of the first polymer layer and the second polymer layer has a density lower than a density of the third polymer layer.

8. The container of claim 6, wherein the first depth of the first line of weakening extends through the composite layer and partially through the third polymer layer.

9. The container of claim 8, wherein the second depth of the second line of weakening extends through the first polymer layer and the second polymer layer and extends partially through the third polymer layer.

10. The container of claim 9, wherein the third polymer layer is devoid of lines of weakening at a depth greater than the first depth from the exterior surface of the barrier member and from a depth greater than the second depth from the interior surface of the barrier member.

11. The container of claim 10, wherein the first depth is about 0.46 mm.

12. The container of claim 11, wherein the second depth is about 0.1 mm.

13. The container of claim 12, wherein the central portion of the barrier member has a thickness of about 0.55 mm.

14. The container of claim 10, wherein the barrier member comprises an access feature for facilitating at least partial separation of the central portion from the marginal portion of the barrier member.

15. The container of claim 14, wherein the access feature is foldably connected to a portion of the central portion of the barrier member.

16. A combination of blanks for forming a container for holding at least one article, the combination of blanks comprising:
a body blank for forming a body extending at least partially around an interior of the container formed from the combination of blanks;
a lid blank for forming reclosable lid engaged with the body when the container is formed from the combination of blanks such that the reclosable lid repositionable between an open position, in which the reclosable lid is moved away from the interior of the container formed from the combination of blanks, and a closed position, in which the reclosable lid at least partially overlies the interior of the container formed from the combination of blanks;
a bottom blank for forming a closed bottom engaged with the body of the container formed from the combination of blanks; and
a barrier blank formed of a laminate structure defining an exterior surface and an interior surface of the barrier blank and for being positioned in the interior of the container formed from the combination of blanks, the barrier blank comprising a central portion at least partially separably connected to a marginal portion at a first line of weakening and a second line of weakening, the first line of weakening extending to a first depth from the exterior surface of the barrier blank and the second line of weakening extending to a second depth from the interior surface of the barrier blank, the first depth different than the second depth, the marginal portion for being attached to the body of the container formed from the combination of blanks.

17. The combination of claim 16, wherein the central portion of the barrier blank is at least partially separable from the marginal portion of the barrier member for exposing a barrier opening for accessing at least one article in the interior of the container formed from the combination of blanks.

18. The combination of claim 17, wherein the laminate structure comprises a composite layer and at least one polymer layer.

19. The combination of claim 18, wherein the at least one polymer layer is a polymer layer of a plurality of polymer layers.

20. The combination of claim 19, wherein the polymer layer comprises high density polyethylene (HDPE).

21. The combination of claim 20, wherein the polymer layer is a third polymer layer in at least partial face-to-face contact with the composite layer, and the laminate structure comprises a second polymer layer in at least partial face-to-face contact with the third polymer layer and a first polymer layer in at least partial face-to-face contact with the second polymer layer.

22. The combination of claim 21, wherein each of the first polymer layer and the second polymer layer comprises polyethylene, and each of the first polymer layer and the second polymer layer has a density lower than a density of the third polymer layer.

23. The combination of claim 21, wherein the first depth of the first line of weakening extends through the composite layer and partially through the third polymer layer.

24. The combination of claim 23, wherein the second depth of the second line of weakening extends through the first polymer layer and the second polymer layer and extends partially through the third polymer layer.

25. The combination of claim 24, wherein the third polymer layer is devoid of lines of weakening at a depth greater than the first depth from the exterior surface of the barrier member and from a depth greater than the second depth from the interior surface of the barrier member.

26. The combination of claim 25, wherein the first depth is about 0.46 mm.

27. The combination of claim 26, wherein the second depth is about 0.1 mm.

28. The combination of claim 27, wherein the central portion of the barrier member has a thickness of about 0.55 mm.

29. The combination of claim 28, wherein the barrier member comprises an access feature for facilitating at least partial separation of the central portion from the marginal portion of the barrier member.

30. The combination of claim 29, wherein the access feature is foldably connected to a portion of the central portion of the barrier member.

31. A method of forming a container for holding at least one article, the method comprising:
obtaining a body blank;
obtaining a lid blank;
obtaining a bottom blank;
obtaining a barrier blank, the barrier blank formed of a laminate structure defining an exterior surface and an interior surface, the barrier blank comprising a central portion at least partially separably connected to a marginal portion at a first line of weakening and a second line of weakening, the first line of weakening extending to a first depth from the exterior surface of the barrier blank and the second line of weakening extending to a second depth from the interior surface of the barrier blank, the first depth different than the second depth;
forming a body of the container from the body blank such that the body extends at least partially around an interior of the container;
forming a reclosable lid from the lid blank such that the reclosable lid is engaged with the body, the reclosable lid repositionable between an open position, in which the reclosable lid is moved away from the interior of the container, and a closed position, in which the reclosable lid at least partially overlies the interior of the container;
forming a closed bottom from the bottom blank such that the closed bottom is engaged with the body of the container; and
attaching the marginal portion of the barrier blank to the body of the container to form a barrier member.

32. The method of claim 31, wherein the central portion of the barrier blank is at least partially separable from the marginal portion of the barrier blank for exposing a barrier opening for accessing at least one article in the interior of the container.

33. The method of claim 32, wherein the laminate structure comprises a composite layer and at least one polymer layer.

34. The method of claim 33, wherein the at least one polymer layer is a polymer layer of a plurality of polymer layers.

35. The method of claim 34, wherein the polymer layer comprises high density polyethylene (HDPE).

36. The method of claim 35, wherein the polymer layer is a third polymer layer in at least partial face-to-face contact with the composite layer, and the laminate structure comprises a second polymer layer in at least partial face-to-face contact with the third polymer layer and a first polymer layer in at least partial face-to-face contact with the second polymer layer.

37. The method of claim 36, wherein each of the first polymer layer and the second polymer layer comprises polyethylene, and each of the first polymer layer and the second polymer layer has a density lower than a density of the third polymer layer.

38. The method of claim 36, wherein the first depth of the first line of weakening extends through the composite layer and partially through the third polymer layer.

39. The method of claim 38, wherein the second depth of the second line of weakening extends through the first polymer layer and the second polymer layer and extends partially through the third polymer layer.

40. The method of claim 39, wherein the third polymer layer is devoid of lines of weakening at a depth greater than the first depth from the exterior surface of the barrier member and from a depth greater than the second depth from the interior surface of the barrier member.

41. The method of claim 40, wherein the first depth is about 0.46 mm.

42. The method of claim 41, wherein the second depth is about 0.1 mm.

43. The method of claim 42, wherein the central portion of the barrier member has a thickness of about 0.55 mm.

44. The method of claim 40, wherein the barrier member comprises an access feature for facilitating at least partial separation of the central portion from the marginal portion of the barrier member.

45. The method of claim 44, wherein the access feature is foldably connected to a portion of the central portion of the barrier member.
